(19) United States
(12) Patent Application Publication
(10) Pub. No.: US 2011/0258847 A1
(43) Pub. Date: Oct. 27, 2011

(54) ROBOTIC CELL

(75) Inventors: Ken Meisho, Yokohama-shi (JP); Mikio Nakasugi, Tama-shi (JP); Mahito Negishi, Tachikawa-shi (JP); Yuji Matsuo, Machida-shi (JP)

(73) Assignee: CANON KABUSHIKI KAISHA, Tokyo (JP)

(21) Appl. No.: 13/079,183

(22) Filed: Apr. 4, 2011

(30) Foreign Application Priority Data
Apr. 21, 2010 (JP) 2010-097994

(51) Int. Cl. B23P 19/00

(52) U.S. Cl. 29/700

(57) ABSTRACT

A robotic cell enables a robotic station to be downsized and both high maintainability and high rigidity to be attained. To this end, the robotic cell for assembling parts by using multiple robots includes multiple booths for housing multiple trestles, on each of which a pair of robotic arms are mounted, with the trestles adjoining one another. Each trestle has an opening portion on one side surface thereof, through which a power controller box is carried in and out. To compensate for a decrease in rigidity of the trestle due to the opening portion, a connecting member is used for coupling two trestles adjacent to each other across the respective booths. Both end portions of each connecting member are fastened to the both trestles with screws, respectively.

### BACKGROUND OF THE INVENTION

1. Field of the Invention

The present invention relates to a robotic cell which is configured by combining general-purpose unitized assembly apparatuses (robotic stations) including robots to be incorporated in a production system.

2. Description of the Related Art

In recent years, small-size electric products and electronic products have increasingly been produced in a style of low-volume, high-variety production in a shorter product life cycle. Further, line layout of a production line for those products tends to be changed frequently so as to suit the kind of product to be produced. When the production line is shifted to another kind of product, it takes time to change the line layout and dedicated tools need to be prepared therefor. Hence, except that a certain volume of products are produced collectively, manual cell production is conducted in many cases in place of automated production. In recent years, however, even in such a case as described above, there has been a demand for automation of the production line to seek for consistent quality of products and deal with a sudden increase in production volume.

Therefore, as disclosed in Japanese Patent Application Laid-Open No. H07-001298 and Japanese Patent Application Laid-Open No. 2008-229738, the robotic stations that may be used for general purposes are attracting attention. In the robotic cells using those robotic stations, the multiple robotic stations that may be used for general purposes are rearranged so as to suit every production plan, to thereby build a new robotic cell for processing, assembly, and transport of workpieces to be processed. Further, to deal with a sudden increase in production volume or the like, the general-purpose robotic stations are removed from the production line in which the production volume is decreased and diverted into another robotic cell.

What is important in configuring such a robotic station is downsizing and attaining higher-speed of the robotic station. Even in the case of the robotic station that may be used for general purposes, if the robotic station occupies a larger area than that of a manual assembly line or if it takes longer time than manual work, the use of the robotic station is less advantageous.

In the robotic station disclosed in Japanese Patent Application Laid-Open No. H07-001298, a single station houses the pair of conveyor apparatuses capable of conveying workpieces in opposite directions, the workpiece transport pallets placed on the movable portions of the conveyor apparatuses, the robots for performing processing, assembly, and the like of the workpieces, and the measurement apparatuses. In the trestle portion of the housing, the control portions of the robots and the measurement apparatuses placed on the station are arranged. The robotic stations are coupled to each other by the coupling pin, and the transport pallet turning units are provided at the start and terminal points of the multiple robotic stations, to thereby configure the production line. Accordingly, the layout, movement, and process change of the production line can be performed with ease.

Further, the robotic station disclosed in Japanese Patent Application Laid-Open No. 2008-229738 includes the robotic arm having a circular arc operation area in the roof portion, and the work space of the robotic station has a hexagonal shape. In the roof portion, the camera capable of viewing the surroundings of the robotic station is provided, and the robotic station includes the self-travelable wheeled platform. Accordingly, a production line suitable for a production plan can be configured automatically.

However, those robotic stations are designed as production systems focusing on easiness of movement and process change, and hence there are the following unaddressed problems.

In the robotic station disclosed in Japanese Patent Application Laid-Open No. H07-001298, the grooves are formed in part of adjacent stations, and the coupling pin having the pair of flanges is simply bridged over the grooves to couple the stations. Hence, the positions of the adjacent stations are not fixed. Therefore, when a precise work process is executed, rigidity of the lone station needs to be ensured to suppress mechanical vibration, and hence the trestle portion of the housing is formed by a thick, rigid structural member. As a result, the volume of the trestle is limited, and accordingly, when the robotic station is downsized, a space for maintenance of the control portions cannot be ensured as the volume is reduced, which lowers workability.

If the structural member of the trestle is partially cut out for ensuring high maintainability, rigidity of the trestle decreases in turn. The decrease in rigidity causes the trestle itself to vibrate due to the operation of the robot, and the vibration is therefore intense at the distal end portion of the robotic arm, with the result that failure occurs in assembly, transport, and the like. Further, it takes time to stabilize the vibration at a desired amplitude, which leads to an increase in tact time and other troubles. Further, in a case where an auxiliary member is provided so as to cover the cut-out portion for preventing the decrease in rigidity, it is necessary to detach the auxiliary member every time the trestle is accessed, with the result that the maintainability decreases. As described above, it is difficult to attain both high maintainability and high rigidity of the trestle.

Further, in the robotic station disclosed in Japanese Patent Application Laid-Open No. 2008-229738, the trestle includes the wheeled platform on the bottom portion thereof, and hence, even though the trestle itself has rigid structure, the rigidity cannot be ensured with respect to a floor. Because the wheeled platform is provided, the trestle itself is unstable and the volume of the housing in the trestle is also limited. Hence, similarly to the case of Japanese Patent Application Laid-Open No. 07-001298, there is a problem that the downsizing of the robotic station and both high maintainability and high rigidity cannot be attained.

### SUMMARY OF THE INVENTION

The present invention has an object to provide a robotic cell that enables in particular both high maintainability and high rigidity of a trestle to be attained in downsizing a robotic station.

In order to solve the above-mentioned problems, the present invention provides a robotic cell for assembling parts by using multiple robots, including: multiple trestles on which the multiple robots are mounted, respectively; opening portions, which are open in respective one side surfaces of the multiple trestles; a connecting member configured to couple two adjacent trestles on the one side surfaces of the multiple trestles with the multiple trestles adjoining one another so that the opening portions of the multiple trestles are oriented in one direction; and fastening units configured to fasten the connecting member to the two adjacent trestles while bringing both end portions of the connecting member into surface contact with the two adjacent trestles, respectively.

In the opening portions of the trestles of the adjacent robotic stations, the connecting member is brought into surface contact with pillars of the adjacent trestles to couple the trestles, with the result that high maintainability can be ensured and also rigidity of the trestle can be increased. Accordingly, the vibration that may occur due to a high-speed operation of the robotic arm can be suppressed, and the failure in assembly and transport can be prevented. Further, the stabilization time is reduced, which contributes to reduction in tact time.

Further features of the present invention will become apparent from the following description of exemplary embodiments with reference to the attached drawings.

### BRIEF DESCRIPTION OF THE DRAWINGS

FIG. 1A is a perspective view illustrating structure of each robotic station of a robotic cell according to a first embodiment of the present invention.

FIG. 1B is a perspective view illustrating the entire robotic cell.

FIG. 2A is a perspective view illustrating structure of a trestle of the robotic station of FIGS. 1A and 1B.

FIG. 2B is a perspective view illustrating connection structure of three trestles.

FIG. 3 is a perspective view illustrating the trestles and power controller boxes of the robotic stations of FIGS. 1A and 1B.

FIG. 4 is a perspective view illustrating connection structure of trestles of robotic stations of a robotic cell according to a second embodiment of the present invention.

### DESCRIPTION OF THE EMBODIMENTS

### First Embodiment

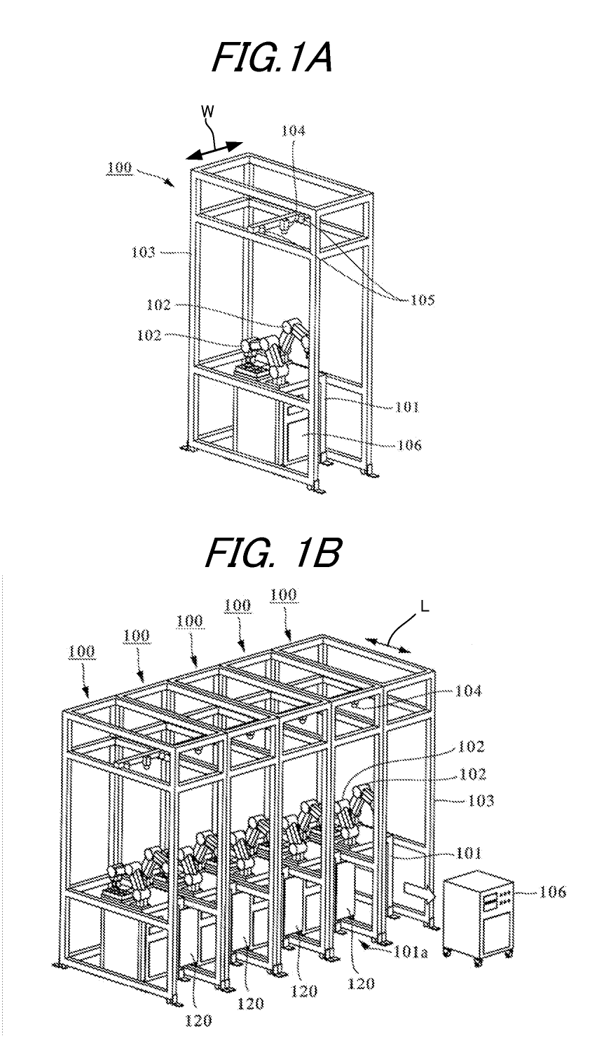

FIGS. 1A and 1B illustrate a robotic cell according to a first embodiment of the present invention. This apparatus is configured by combining multiple robotic stations 100 on each of which a robot for assembling parts is mounted. Referring to FIG. 1A, each robotic station 100 mainly includes a trestle 101, a pair of robotic arms 102 constituting the robot, a booth 103, a camera 104, and illumination lamps 105. Referring to FIG. 1B, the robotic cell serving as a serial production system is built by combining the multiple robotic stations 100.

Each booth 103 is a frame constructed by rigid pillars so that the trestle 101 is housed therein and the camera 104 is fixed thereto in order to measure the position and posture of workpieces and fed parts in a work space on the trestle. A width of the booth 103 in a width direction W is set to a value enough to space apart the trestle 101 and each pillar of the booth 103 with no contact therebetween. Further, a length of the booth 103 in a longitudinal direction L is set to a value enough to enclose with no interference a movable range of the robotic arms 102 including end effectors. A height of the booth 103 is set to a value equal to or larger than a sum of the trestle height and a maximum reach height of the robotic arms 102 including the end effectors, and is adapted to a focal length of the camera during image taking. The trestle 101 is installed substantially at a center portion of the installation area of the booth 103.

In the upper portion of the booth 103, there are installed the camera 104 for measuring the position of the workpieces to be assembled and the fed parts, and the illumination lamps 105 for image taking. The camera 104 and the illumination lamps 105 each have a mechanism capable of adjusting the position and posture thereof to obtain an optimum condition for image taking.

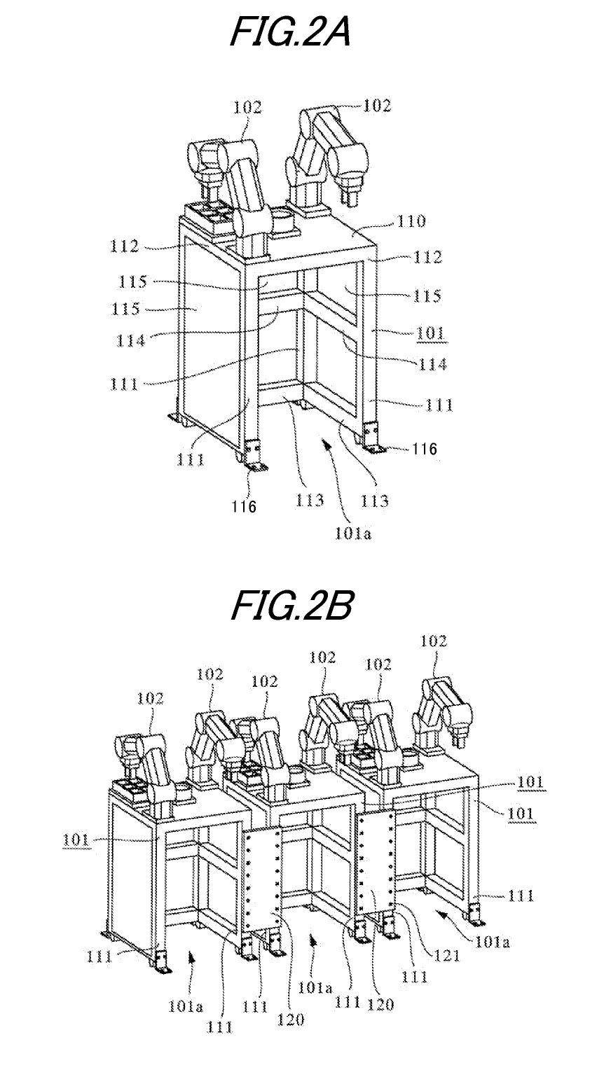

FIG. 2A illustrates structure of the trestle 101. Each trestle 101 is a case having the pair of robotic arms 102 mounted thereon and providing a work space for the robot to perform various kinds of work. The trestle 101 has a stainless top plate 110 which functions as the work space and has a square shape. To the top plate 110, for example, a pedestal on which various kinds of tools to be used by the robotic arms 102 are placed, and a feeding apparatus for feeding a tray in which the parts are placed may be fixed.

The trestle 101 includes the top plate 110, a structure including pillars 111, upper beams 112, lower beams 113, and intermediate beams 114, and side plates 115 arranged on side surfaces of the trestle 101 excluding one side surface. The trestle 101 is devoid of the intermediate beam 114 and the lower beam 113 only on the one side surface thereof, and instead forms an opening portion 101a that is open in the one side surface.

On a lower surface of the structure of the trestle 101, casters are provided so that the trestle 101 may move easily, and feet (not shown) having adjusting screws for leveling the top plate 110 are installed. Further, in order to suppress vibration that may occur as the robot operates, there are provided fixing brackets 116 through which anchor bolts are inserted and tighten to fix the trestle itself to a floor.

The robotic arm 102 is a robotic arm capable of six-axis control. To a distal end portion of each arm, various end effectors may be attached depending on various kinds of work. The end effector corresponds to a human hand or fingers, and for example, a small-size end effector that enables detailed work is attached to one of the robotic arms while an end effector for handling a relatively large member is attached to the other robotic arm.

In order to control the robotic arm 102, it is necessary to provide a robot controller and a power source for controlling motors built into the arm and operating the arm based on instruction values. It is further necessary to provide a controller and a power source for an electric screwdriver and the like to be used for the robotic arm to assemble workpieces. The controller, the power source, and the like used in the robotic station are arranged as a power controller box 106 that is collectively carried in and out of the trestle 101. The power controller box 106 has casters attached to a bottom surface thereof, and may therefore be drawn in a front surface direction (opening direction) through the opening portion 101a of the trestle 101 of each robotic station 100 at the time of maintenance or the like.

The robotic cell serving as a serial production system is configured by combining the multiple robotic stations 100. At this time, the opening portions 101a of the respective trestles 101 are arranged in a plane perpendicular to the longitudinal direction L of the booth 103. In other words, the respective trestles 101 in this arrangement adjoin one another so that the opening portions 101a of the respective trestles 101 are oriented in the same opening direction (the longitudinal direction L of the booth 103). In this case, a front side of the robotic station 100 is defined as maintenance side while an opposite side is defined as parts feeding side. With this structure, parts feedings by using the trays are centralized on one side of the robotic cell so that parts feedings by using an automatic guided vehicle or the like are effectively performed. Further, the maintenance side that is the front side of FIG. 1B is regarded as an area which a person may enter, and hence the automated part may be separated from the part in which a person is involved through the intermediation of the robotic cell, which leads to a system with attention to safety.

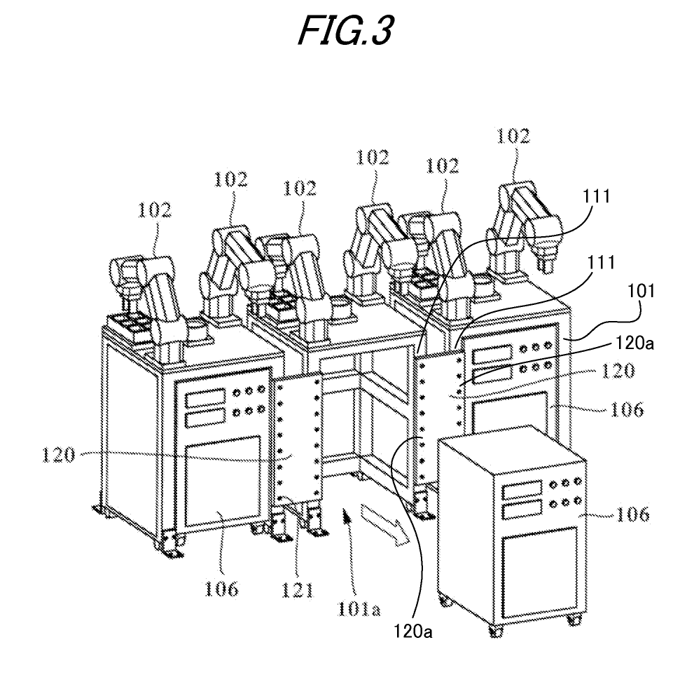

Referring to FIG. 3, the power controller box 106 is stored in the trestle 101 of each robotic station 100 in a state in which the power controller box 106 may be carried in and out of the trestle with its volume substantially equal to that of the trestle. The trestle 101 has the opening portion 101a and hence the trestle 101 has lower rigidity on the side surface provided with the opening portion 101a. When the robot operates, vibration occurs in a direction of the low rigidity, which may raise a fear of failure in transport of workpieces and in assembly.

In view of the above, a connecting member 120 is provided on the side surfaces provided with the opening portions 101a of the trestles 101 so as to rigidly couple two trestles 101 adjacent to each other across the respective booths 103 with the connecting member 120 brought into surface contact with the two trestles 101. The rigid coupling involving the surface contact is realized through the following setting. Both end portions 120a of the connecting member 120, which are to be brought into surface contact with parts having surfaces such as the pillars 111 in the vicinity of the opening portions 101a of the trestles 101, are set so as to have as large an area in the direction of the height as possible. Further, a screw fixing portion 121 serving as a fastening unit is set as a multipoint fastening portion having three points or more at a small pitch.

As described above, the adjacent trestles 101 are integrated with each other to increase the rigidity of the trestles 101 over the entire robotic cell. As a result, the vibration that may occur due to a high-speed operation of the robotic arm 102 can be suppressed, and the failure in assembly and transport can be prevented. Further, the stabilization time is reduced and accordingly the tact time can be reduced. At the same time, the power controller box 106 is freely carried in and out, and accordingly both high maintainability and high rigidity can be attained.

### Second Embodiment

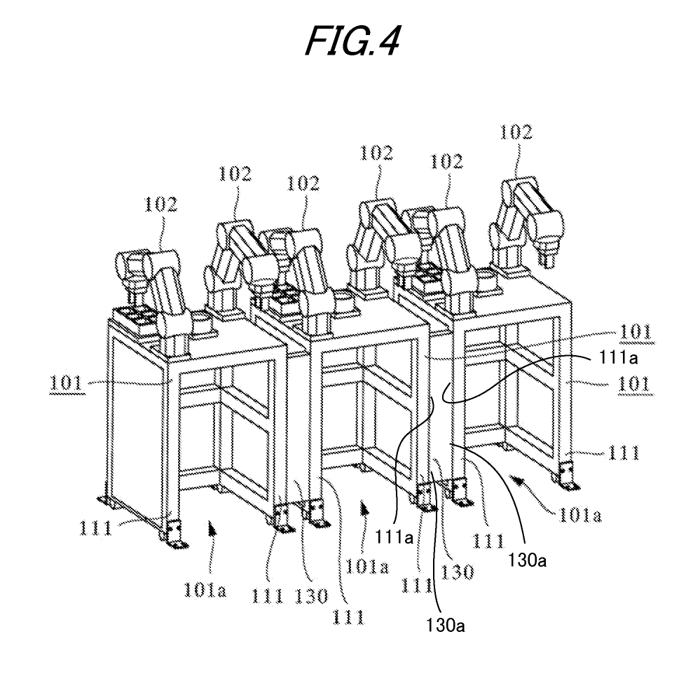

FIG. 4 illustrates a robotic cell according to a second embodiment of the present invention. The second embodiment is different from the first embodiment only in that a connecting member 130 is used. The connecting member 130 is different from the connecting member 120 in the method for connection to the pillars 111 of the trestles 101 of the adjacent robotic stations 100. In this embodiment, the connecting member 130 is arranged between the pillars 111 of the adjacent trestles 101. Then, both end portions 130a of the connecting member 130 are respectively brought into surface contact with opposing surfaces 111a of the pillars 111, and those components are fastened to each other. Accordingly, the adjacent trestles 101 are rigidly coupled to each other to increase the rigidity of the trestles 101.

In a case where two opening portions are provided on two side surfaces of each trestle, respectively, one more connecting portion using the connecting member is only added, and the basic structure and effect are the same as those in the first and second embodiments.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-097994, filed Apr. 21, 2010, which is hereby incorporated by reference herein in its entirety.

What is claimed is:

1. A robotic cell for assembling parts by using multiple robots, comprising:
multiple trestles on which the multiple robots are mounted, respectively;
opening portions, which are open in respective one side surfaces of the multiple trestles;
a connecting member configured to couple two adjacent trestles on the one side surfaces of the multiple trestles with the multiple trestles adjoining one another so that the opening portions of the multiple trestles are oriented in one direction; and
fastening units configured to fasten the connecting member to the two adjacent trestles while bringing both end portions of the connecting member into surface contact with the two adjacent trestles, respectively.

2. A robotic cell according to claim 1, further comprising power controller boxes configured to control the multiple robots, respectively,
wherein the power controller boxes are carried in and out of the respective multiple trestles through the respective opening portions.

3. A robotic cell according to claim 2, wherein the power controller boxes comprise casters on bottom surfaces thereof, and are stored in the respective multiple trestles in a state in which the power controller box can collectively be carried in and out through the opening portions.
